(19) United States
(12) Patent Application Publication
(10) Pub. No.: US 2025/0004481 A1
(43) Pub. Date: Jan. 2, 2025

(54) PATROL TARGET DETECTION METHOD AND APPARATUS, DEVICE, AND STORAGE MEDIUM

(71) Applicant: AUTEL ROBOTICS CO., LTD., Nanshan Dist (CN)

(72) Inventors: Yaxue LI, Shenzhen (CN); Jia XU, Shenzhen (CN)

(21) Appl. No.: 18/761,113

(22) Filed: Jul. 1, 2024

(30) Foreign Application Priority Data
Jun. 30, 2023 (CN) 202310795412.8

(51) Int. Cl. G05D 1/689; G05D 105/85; G06T 7/73; G06V 20/52

(52) U.S. Cl. CPC G05D 1/689; G06T 7/73; G05D 2105/85; G06T 2207/10032; G06T 2207/30232; G06V 20/52; G06V 2201/07

(57) ABSTRACT

The present disclosure provides a patrol target detection method and apparatus, a device, and a storage medium. The method includes: obtaining patrol targets patrolled by a patrol device at a preset patrol position in multiple patrol postures sequentially and geographical positions of the patrol targets, the multiple patrol postures being different, patrol sub-areas patrolled by the patrol device at the preset patrol position in the multiple patrol postures sequentially forming a patrol area; and displaying the patrol targets at the geographical positions in a patrol map. According to the technical solution, errors and omissions in target statistics can be avoided and rapid detection of the patrol targets in the patrol area can be achieved.

This application claims the benefit of and priority to Chinese patent application 202310795412.8, filed Jun. 30, 2023 and titled “PATROL TARGET DETECTION METHOD AND APPARATUS, DEVICE, AND STORAGE MEDIUM,” the entirety of which is hereby incorporated herein by reference.

### BACKGROUND

With the development of science and technology, more and more industries start to choose unmanned aerial vehicle patrol to replace traditional manual patrol. An unmanned aerial vehicle carries multiple tools such as a camera and an infrared sensor. After setting a flying task for the unmanned aerial vehicle, during execution of the flying task, the unmanned aerial vehicle transmits images and videos collected by the unmanned aerial vehicle to a background system in real time. A background operator monitors a patrol picture in real time and determines a target in the picture, thereby implementing remote patrol.

Generally, an area covered by the unmanned aerial vehicle performing the flying task is large, and multiple pictures are collected by the unmanned aerial vehicle. If a target is determined by manually performing whole-process picture monitoring, errors and omissions in target statistics may be caused. In addition, during the execution of the flying task by the unmanned aerial vehicle, because a patrol area is excessively large, conventional patrol requires planning of a patrol path for the area to complete patrol of the area. During the patrol, a time of flying patrol is limited by a battery life of the unmanned aerial vehicle. As a result, multiple flights are required to complete the patrol of the patrol area.

### SUMMARY

The present disclosure relates to the field of target detection, and in particular, to a patrol target detection method and apparatus, a device, and a storage medium.

The present disclosure provides a target detection method and apparatus, a device, and a storage medium, so as to resolve technical problems of error or missed targets in a manual monitoring picture and excessively long patrol time.

According to a first aspect, a patrol target detection method is provided, including:
obtaining patrol targets patrolled by a patrol device at a preset patrol position in multiple patrol postures sequentially and geographical positions of the patrol targets, where the multiple patrol postures are different and patrol sub-areas patrolled by the patrol device at the preset patrol position in the multiple patrol postures sequentially form a patrol area; and
displaying the patrol targets at the geographical positions in a patrol map.

According to a second aspect, a patrol target detection apparatus is provided, including:
a target obtaining module, configured to obtain patrol targets patrolled by a patrol device at a preset patrol position in multiple patrol postures sequentially and geographical positions of the patrol targets, where multiple patrol postures are different; and
a target display module, configured to display the patrol targets at the geographical positions in a patrol map.

According to a third aspect, a computer device is provided, including a memory and one or more processors. The memory is connected to the one or more processors. The one or more processors are configured to execute one or more computer programs stored in the memory. The one or more processors, when executing the one or more computer programs, enables the computer device to implement the patrol target detection method according to the foregoing first aspect.

According to a fourth aspect, a computer-readable storage medium is provided. The computer-readable storage medium stores a computer program. The computer program includes program instructions. The program instructions, when executed by a processor, enables the processor to perform the patrol target detection method according to the foregoing first aspect.

The present disclosure can achieve the following technical effects: all the patrol targets patrolled by the patrol device at the preset patrol position in the patrol map are displayed, and the user can determine, according to the patrol map, all the patrol targets patrolled by the patrol device, so that the user does not need to perform whole-process picture monitoring and errors and omissions in target statistics can be avoided. The patrol device patrols the entire patrol area in a manner of patrolling at the preset patrol position in the multiple patrol postures and the patrol device can patrol all the patrol targets in the patrol area by only changing postures at the preset patrol position, so as to avoid multiple flights, thereby shortening a flight time and achieving rapid detection of the patrol targets in the patrol area.

### BRIEF DESCRIPTION OF THE DRAWINGS

FIG. 1 is a schematic diagram of a patrol system according to an embodiment of the present disclosure.

FIG. 2 is a schematic flowchart of a patrol target detection method according to an embodiment of the present disclosure.

FIG. 3 is a schematic flowchart of obtaining patrol targets patrolled by a patrol device at a preset patrol position in multiple patrol postures sequentially and geographical positions of the patrol targets according to the present disclosure.

FIG. 4 is a schematic diagram of a patrol image obtained by a patrol device in a patrol posture according to an embodiment of the present disclosure.

FIG. 5 is a schematic diagram of displaying patrol targets patrolled by a patrol device in multiple patrol postures in a patrol map according to an embodiment of the present disclosure.

FIG. 6 is a schematic diagram of sequentially displaying patrol targets patrolled by a patrol device in multiple patrol postures in a patrol map according to an embodiment of the present disclosure.

FIG. 7 is a schematic flowchart of another patrol target detection method according to an embodiment of the present disclosure.

FIG. 8 is a schematic diagram of displaying a patrol image corresponding to a patrol target according to an embodiment of the present disclosure.

FIG. 9 is a schematic structural diagram of a patrol target detection apparatus according to an embodiment of the present disclosure.

FIG. 10 is a schematic structural diagram of a computer device according to an embodiment of the present disclosure.

### DETAILED DESCRIPTION

Technical solutions in embodiments of the present disclosure will be described with reference to accompanying drawings in the embodiments of the present disclosure.

The technical solutions of the present disclosure are applicable to a patrol scenario. The patrol scenario may be a scenario in which a patrolling task is performed by flying an unmanned aerial vehicle, or may be a scenario in which a patrolling task is performed by using another patrol device, for example, a scenario in which a patrol robot walks on the ground to perform a patrolling task on the ground.

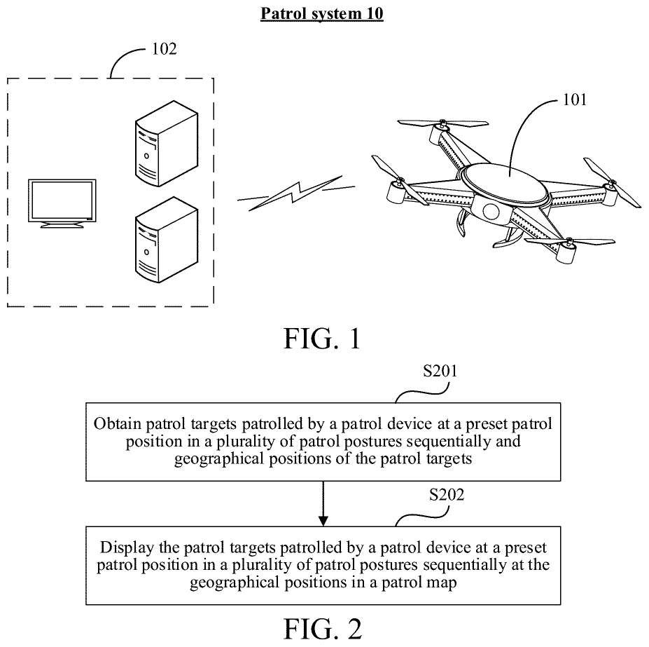

To facilitate understanding, a patrol system involved in the present disclosure is first introduced. First, refer to FIG. 1, which is a schematic diagram of a patrol system according to an embodiment of the present disclosure. As shown in FIG. 1, a patrol system 10 may include a patrol device 101 and a patrol control platform 102. The patrol device 101 is configured to replace a person to move in an area that needs to be patrolled (namely, a patrol area), collect relevant data (image data and data of various sensors) in the patrol area in real time, and transmit collected relevant data to the patrol control platform 102 to complete a patrol task. The patrol control platform 102 is a user-oriented device. The patrol control platform 102 is configured to issue a patrol instruction to the patrol device 101, to instruct the patrol device 101 to perform the patrol task according to the patrol instruction. An area covered by the patrol device performing the patrol task is the patrol area. The patrol control platform 102 may transmit the patrol instruction to the patrol device 101 in response to a user instruction, so that the patrol device 101 performs the patrol task under control of the user. Specifically, the patrol device 101 may be an unmanned aerial vehicle, a patrol robot, or the like. The patrol control platform 102 may include a cloud platform, a back-end server, a human interaction device (for example, a display screen), and the like.

Technical solutions of the present disclosure may be implemented based on the patrol system shown in FIG. 1. The technical solutions of the present disclosure may be applied to a patrol control platform in the patrol system shown in FIG. 1. The following specifically describes the technical solutions of the present disclosure.

Refer to FIG. 2, which is a schematic flowchart of a patrol target detection method according to an embodiment of the present disclosure. As shown in FIG. 2, the method includes the following operations.

S201: Obtain patrol targets patrolled by a patrol device at a preset patrol position in a multiple patrol postures sequentially and geographical positions of the patrol targets.

Herein, the preset patrol position is a geographical position at which the preset patrol device performs the patrol task, and first device position coordinates corresponding to the preset patrol position may be represented as (X0, Y0, Z0). The first device position coordinates are coordinates in a world coordinate system. The coordinates in the world coordinate system may be global positioning system (GPS) coordinates. X0, Y0, Z0 may represent a translation parameter of the patrol device at the preset patrol position relative to an origin of the world coordinate system. In the world coordinate system in which a WGS-84 coordinate system is taken as a GPS coordinate system, the origin of the world coordinate system may be a center of mass of the earth.

The patrol control platform may control the patrol device to move to the preset patrol position to perform the patrol task. The patrol task performed by the patrol device at the preset patrol position is a full coverage scanning task, and an entire area patrolled by the patrol device to perform the full coverage scanning task at the patrol position is referred to as a patrol area. The patrol area takes the patrol position as a center and a maximum coverage radius of the patrol device as a radius. The preset patrol position corresponds to a center position of the patrol area, that is, the preset patrol position is the center position of the patrol area, or the preset patrol position is in a vertical direction in the center of the patrol area.

After the patrol device moves to the preset patrol position, the patrol control platform may take an initial patrol posture of the patrol device as a target patrol posture, control the patrol device to obtain a patrol image in the target patrol posture, detect a patrol target in the patrol image and a geographical position of the patrol target, obtain the patrol target of the patrol device in the target patrol posture and the geographical position of the patrol target, determine the patrol area corresponding to the patrol image, and obtain a patrol sub-area patrolled by the patrol device in the patrol posture. Then, the target patrol posture of the patrol device is adjusted, and the patrol target of the patrol device in the target patrol posture, the geographical position of the patrol target, and the patrol sub-area patrolled by the patrol device are determined. By analogy, the target patrol posture of the patrol device is adjusted, and the patrol targets patrolled by the patrol device at the preset patrol position in the multiple patrol postures sequentially and the geographical positions of the patrol targets may be obtained. The patrol sub-areas patrolled by the patrol device in the multiple patrol postures form the patrol area.

The patrol posture of the patrol device includes a roll angle, a heading angle, and a pitch angle. The adjustment of the target patrol posture of the patrol device refers to adjusting the heading angle and/or the pitch angle of the patrol device, so that the patrol device patrols to different patrol sub-areas. The target patrol posture of the patrol device may be adjusted according to a field of view (FOV) of a camera of the patrol device. For example, if the initial patrol posture of the patrol device is {an initial heading angle: 0; an initial pitch angle: 90}, FOV parameters of the camera are {H=20, V=10}, H is a horizontal angle of view of the camera, and V is a vertical angle of view of the camera, the heading angle of the patrol device may be sequentially adjusted to {0, 20, 40, . . . , 340, and 360} and the pitch angle of the patrol device may be adjusted to {90, 80, 70, . . . , 20, 10, 0}. The heading angle and the pitch angle may be combined to obtain 18*10 patrol postures. Therefore, 180 patrol sub-areas may be obtained and the 180 patrol sub-areas are combined into the patrol area that takes the preset patrol position as the center.

In a process of adjusting the target patrol posture of the patrol device, in a feasible implementation, the patrol posture of the patrol device may be adjusted based on gradual adjustment and the patrol target in the patrol posture and the geographical position of the patrol target are obtained.

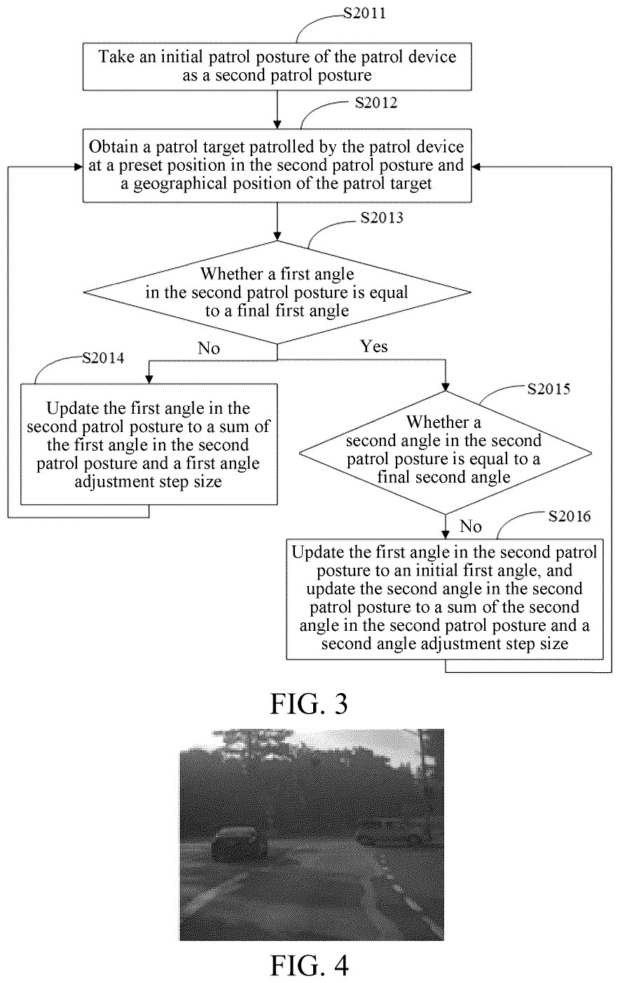

A process of adjusting the patrol posture of the patrol device based on gradual adjustment to obtain the patrol target in the patrol posture and the geographical position of the patrol target may be referred to FIG. 3. FIG. 3 is a schematic flowchart of obtaining the patrol targets patrolled by the patrol device at the preset patrol position in the multiple patrol postures sequentially and the geographical positions of the patrol targets according to the present disclosure, including the following operations.

S2011: Take the initial patrol posture of the patrol device as a second patrol posture.

Herein, the initial patrol posture may be a posture in which the patrol device starts patrol at the preset patrol position. The initial patrol posture includes a roll angle, an initial heading angle and an initial pitch angle. The initial heading angle may be a maximum value or a minimum value in a heading angle range of the patrol device. For example, if the heading angle of the patrol device ranges from 0° to 360°, the initial heading angle may be 0°, or may be 360°. The initial pitch angle may be a maximum value or a minimum value in a pitch angle range of the patrol device. For example, if the heading angle of the patrol device ranges from 0° to 90°, the initial pitch angle may be 0°, or may be 90°. The heading angle range and the pitch angle range may be set based on the patrol area.

The second patrol posture is a posture in which the patrol device performs patrol. The second patrol posture includes a roll angle, a heading angle and a pitch angle. Because the patrol posture of the patrol device is adjusted by adjusting the heading angle and/or the pitch angle of the patrol device, the roll angle of the patrol device may be fixed. For ease of description, the following describes the second patrol posture including a first angle and a second angle. The first angle is the heading angle and the second angle is the pitch angle; alternatively, the first angle is the pitch angle and the second angle is the heading angle.

S2012: Obtain a patrol target patrolled by the patrol device at a preset position in the second patrol posture and a geographical position of the patrol target.

Herein, for an implementation of how to specifically obtain the patrol target patrolled by the patrol device at the preset position in the second patrol posture and the geographical position of the patrol target, reference may be made to subsequent descriptions of operations A1 to A2. Excessive descriptions are not made herein.

S2013: Determine whether the first angle in the second patrol posture is equal to a final first angle.

Herein, the final first angle is a maximum value or a minimum value in an angle range corresponding to the first angle. Taking the first angle being the heading angle as an example, when the initial heading angle is a maximum value in the heading angle range, the final first angle is a minimum value in the heading angle range; or when the initial heading angle is a minimum value in the heading angle range, the final first angle is a maximum value in the heading angle range. The same is true when the first angle is the pitch angle. Details are not described herein again.

In a case that the first angle in the second patrol posture is not equal to the final first angle, a patrol sub-area within an angle range corresponding to the first angle has not been patrolled at the second angle in the current second patrol posture and operation S2014 is performed. In a case that the first angle in the second patrol posture is equal to the final first angle, a patrol sub-area within an angle range corresponding to the first angle has been patrolled at the second angle in the current second patrol posture and operation S2015 is performed.

S2014: Update the first angle in the second patrol posture to a sum of the first angle in the second patrol posture and a first angle adjustment step size, and return to perform operation S2012.

Herein, the first angle adjustment step size is a step size set based on the angle range of the first angle for each adjustment of the first angle. The first angle adjustment step size may be set according to FOV parameters of the camera. Taking the FOV parameters of the camera being {H=20, V=10} as an example, if the first angle is the heading angle, the first angle adjustment step size may be −20° or 20°. If the initial heading angle is 0°, the first angle adjustment step size may be 20°. If the initial heading angle is 360°, the first angle adjustment step size may be −20°. If the first angle is the pitch angle, the first angle adjustment step size may be −10° or 10°. If the initial pitch angle is 0°, the first angle adjustment step size may be 10°. If the initial pitch angle is 90°, the first angle adjustment step size may be −10°.

S2015: Determine whether the second angle in the second patrol posture is equal to a final second angle.

Herein, the final second angle is a maximum value or a minimum value in an angle range corresponding to the second angle. Taking the second angle being the pitch angle as an example, when the initial pitch angle is a maximum value in a pitch angle range, the final second angle is a minimum value in the pitch angle range. When the initial pitch angle is a minimum value in the pitch angle range, the final second angle is a maximum value in the pitch angle range. The same is true when the second angle is the heading angle. Details are not described herein again.

In a case that the second angle is equal to the final second angle, the entire patrol area has been patrolled currently and the current patrol procedure is ended. In a case that the second angle is not equal to the final second angle, the patrol sub-area within the angle range corresponding to the second angle has not been patrolled currently and operation S2016 is performed.

S2016: Update the first angle in the second patrol posture to an initial first angle, update the second angle in the second patrol posture to a sum of the second angle in the second patrol posture and a second angle adjustment step size and return to perform operation S2012.

Herein, if the first angle is the heading angle, the initial first angle is the foregoing initial heading angle. If the first angle is the pitch angle, the initial first angle is the foregoing initial pitch angle.

The second angle adjustment step size is a step size set based on the angle range of the second angle for each adjustment of the second angle. The second angle adjustment step size may be set according to FOV parameters of the camera. Taking the FOV parameters of the camera being {H=20, V=10} as an example, assuming that the second angle is the pitch angle, the second angle adjustment step size may be −10° or 10°. If the initial pitch angle is 0°, the first angle adjustment step size may be 10°. If the initial pitch angle is 90°, the first angle adjustment step size may be −10°.

In the foregoing process shown in FIG. 3, the heading angle and the pitch angle of the patrol device are gradually adjusted, so that the patrol device is in the multiple patrol postures sequentially and the patrol device can perform patrol in the multiple patrol postures sequentially, thereby avoiding omissions of some patrol sub-areas and ensuring that the patrol area can be completely patrolled.

For any target patrol posture of the multiple patrol postures, a patrol target of the patrol device in the target patrol posture and a geographical position of the patrol target may be determined through the following operations A1 to A2.

A1: Perform patrol target recognition on the second patrol image to obtain a second patrol target and first image coordinates of the second patrol target in the second patrol image.

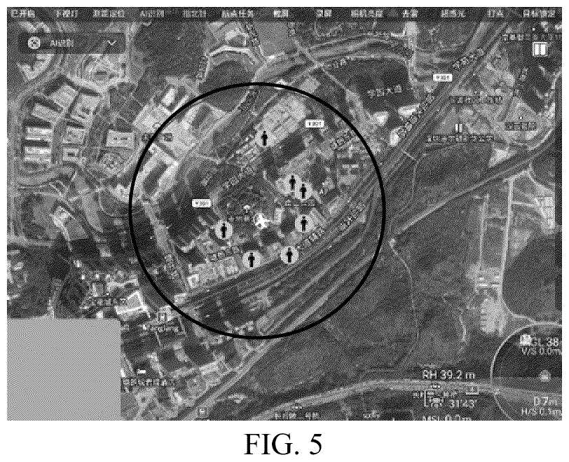

Herein, the second patrol image is a patrol image obtained by the patrol device at the preset patrol position in the target patrol posture. For example, the second patrol image may be as shown in FIG. 4.

In a possible implementation, patrol target recognition may be performed on the second patrol image through a target recognition model to obtain the second patrol target and first image coordinates of the second patrol target in the second patrol image.

The target recognition model may be a model trained based on a deep learning technology for recognizing the patrol target. The target recognition model includes, but is not limited to, a region convolutional neural networks (RCNN) model, a you only look once (YOLO) model, a single shot multibox detector (SSD) model and the like. This is not limited in the present disclosure.

After the second patrol image obtained by the patrol device at the preset patrol position in the target patrol posture is inputted to the target recognition model, the target recognition model may output information {ut, vt, w, h, c} of the patrol target in the second patrol image in the second patrol image. The patrol target in the second patrol image is the second patrol target, (ut, vt) is pixel coordinates of a center point of the second patrol target in the second patrol image, w and h are a width and a height of the second patrol target in the second patrol image respectively and c is a category of the second patrol target. For example, if the patrol task performed by the patrol device is a road patrol task, the category of the second patrol target may be one of objects on the road, such as a pedestrian, a vehicle, a traffic light sign and the like.

It is to be understood that, (ut, vt) may alternatively be converted to coordinates (xt, yt) in an image coordinate system, coordinates in the image coordinate system may be converted from coordinates in the pixel coordinate system and the coordinates in the image coordinate system and the coordinates in the pixel coordinate system satisfy the following conversion relationship: x=(u−uo)*W, and y=(v−vo)*H. (x, y) represent coordinates in the image coordinate system, (u, v) represent coordinates in the pixel coordinate system, W and H are a width and a height of the second patrol image respectively and (uo, vo) are pixel coordinates of the center of the second patrol image. The first image coordinates of the second patrol target in the second patrol image may be (ut, vt), or may be (xt, yt).

A2: Perform coordinate conversion on the first image coordinates of the second patrol target in the second patrol image to obtain first geographical position coordinates of the second patrol target.

Herein, the first geographical position coordinates are coordinates in the world coordinate system. The first geographical position coordinates are represented as (Xt, Yt, Zt).

Coordinate conversion may be performed on the first image coordinates of the second patrol target in the second patrol image through operations A21 and A22.

A21: Determine a target conversion matrix according to the target patrol posture and the first device position coordinates corresponding to the preset patrol position.

The target patrol posture may be represented as (γ, θ, φ), where γ is a heading angle and refers to an angle of rotation relative to a z-axis of the world coordinate system, θ is a roll angle and refers to an angle of rotation relative to an x-axis of the world coordinate system and φ is a pitch angle and refers to an angle of rotation relative to a y-axis of the world coordinate system.

The target conversion matrix is configured for representing a conversion relationship between the pixel coordinate system and the world coordinate system when the patrol device obtains the second patrol image at the preset patrol position in the target patrol posture. The target conversion matrix may include a first projection conversion matrix and a second projection conversion matrix. The first projection conversion matrix is configured for representing a conversion relationship between a camera coordinate system and a device coordinate system. The second projection conversion matrix is configured for representing a conversion relationship between the device coordinate system and the world coordinate system. The first projection conversion matrix may be represented as R1. Since the camera is fixed to the patrol device and a relative positional relationship between the camera and the patrol device is fixed, the first conversion matrix may be obtained through pre-calibration. The second conversion matrix includes a rotation matrix R2 and a translation vector T. The rotation matrix R2 may be obtained according to the target patrol posture. The translation vector T is obtained based on the first device position coordinates.

A22: Perform coordinate conversion on first image coordinates of the second patrol target in the second patrol image according to the target conversion matrix to obtain first geographical position coordinates.

Herein, coordinate conversion may be performed on the first image coordinates of the second patrol target in the second patrol image according to the following conversion formulas (1) to (3) to obtain the first geographical position coordinates:

P2=ZK−1P1 (1)

P3=R1P2 (2)

P4=R2P3+T (3)

Where, K is a camera internal parameter matrix of the camera in the patrol device and P1 is a coordinate in the pixel coordinate system. P1 herein may be (ut, vt, 1), P2 is a coordinate in the camera coordinate system, P3 is a coordinate in the device coordinate system of the patrol device and P4 is a coordinate in the world coordinate system.

The geographical positions of the patrol targets are determined through target recognition and coordinate conversion, so that the geographical positions of the patrol targets can be accurately determined.

After the patrol device adjusts the target patrol posture each time, according to the patrol target of the patrol device in the target patrol posture and the geographical position of the patrol target in the implementations described in operations A1 to A2 above, the patrol targets patrolled by the patrol device at the preset patrol position in the multiple patrol postures sequentially and the geographical positions of the patrol targets may be obtained.

After the patrol device adjusts the target patrol posture to obtain the second patrol image, a patrol map area corresponding to the second patrol image may be further determined as a target patrol sub-area.

The patrol map area corresponding to the second patrol image may be obtained through the following operations B1 to B3.

B1: Obtain vertex image coordinates of the second patrol image.

The vertex image coordinates may be coordinates in the pixel coordinate system, or may be coordinates in the image coordinate system. In a case that the vertex image coordinates are coordinates in the pixel coordinate system, the vertex image coordinates of the second patrol image include (0, 0, 1), (0, H, 1), (W, 0, 1) and (W, H, 1), which respectively represent coordinates of an upper left corner, a lower left corner, an upper right corner and a lower right corner of the second patrol image in the pixel coordinate system.

B2: Perform coordinate conversion on vertex image coordinates of the second patrol image to obtain patrol position coordinates corresponding to the second patrol image.

The patrol position coordinates are coordinates in the world coordinate system. The patrol position coordinates corresponding to the second patrol image include (X1, Y1, Z1), (X2, Y2, Z2), (X3, Y3, Z3) and (X4, Y4, Z4) respectively represent coordinates of the upper left corner, the lower left corner, the upper right corner and the lower right corner of the second patrol image in the world coordinate system.

Coordinate conversion may be performed on vertex image coordinates of the second patrol image through operations B21 and B22.

B21: Determine a target conversion matrix according to the target patrol posture and the first device position coordinates corresponding to the preset patrol position.

Herein, for a specific implementation of operation B21, reference may be made to the foregoing descriptions of operation A21. Details are not described herein again.

B22: Perform coordinate conversion on the vertex image coordinates of the second patrol image according to the target conversion matrix to obtain the patrol position coordinates corresponding to the second patrol image.

Herein, coordinate conversion may be performed on the vertex image coordinates of the second patrol image according to the conversion formulas (1) to (3) in the foregoing operation A22 to obtain the patrol position coordinates corresponding to the second patrol image. P1 herein may be (0, 0, 1), (0, H, 1), (W, 0, 1) or (W, H, 1).

B3: Determine, in the patrol map, a sub-area formed by enclosing patrol position coordinates corresponding to the second patrol image as a patrol map area corresponding to the second patrol image.

Map points corresponding to the four patrol position coordinates may be determined in the patrol map to obtain four map points. The four map points are connected in the patrol map to obtain the patrol map area corresponding to the second patrol image.

After the patrol device adjusts the target patrol posture and obtains the second patrol image each time, multiple patrol sub-areas patrolled by the patrol device at the preset patrol position in the multiple patrol postures may be obtained according to the implementations described in the foregoing operations B1 to B3 and the multiple patrol sub-areas are combined to obtain the patrol area.

S202: Display the patrol targets patrolled by the patrol device at the preset patrol position in the multiple patrol postures sequentially at the geographical positions corresponding to the patrol targets in the patrol map.

For example, referring to FIG. 5, a circle in FIG. 5 is a patrol area patrolled by a patrol device at the preset patrol position in multiple patrol postures. Patrol targets patrolled by the patrol device at the preset patrol position in the multiple patrol postures sequentially are displayed at geographical positions corresponding to the patrol targets in the patrol map, as shown in the content of the circle in FIG. 5.

Since the multiple patrol postures of the patrol device are performed sequentially, the patrol targets patrolled by the patrol device at the preset patrol position are sequentially displayed in the patrol map as changes of the patrol postures, so that the patrol targets in the entire patrol area are gradually displayed in the patrol map. For example, refer to FIG. 5, which is a schematic diagram of sequentially displaying, in the patrol map, the patrol targets patrolled by the patrol device at the preset patrol position in the multiple patrol postures sequentially.

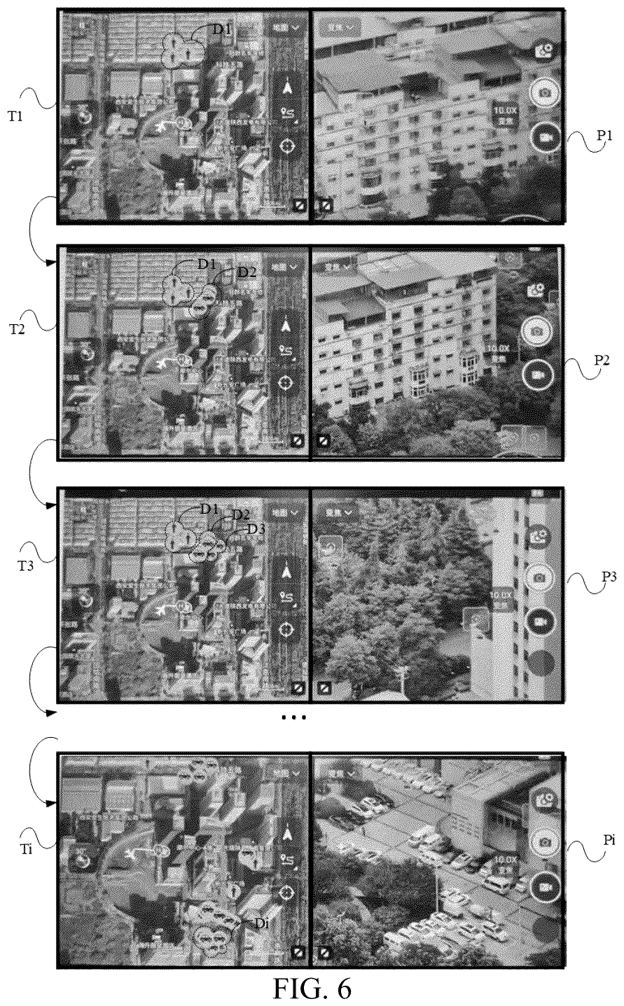

In a patrol posture p1, a patrol image patrolled by the patrol device is shown as P1 in FIG. 6, a patrol target patrolled by the patrol device in the patrol posture p1 is displayed in the patrol map as shown as T1 in FIG. 6 and a patrol target D1 in T1 is the patrol target patrolled by the patrol device in the patrol posture p1. A patrol posture p2 is obtained after the heading angle of the patrol device is adjusted. In the patrol posture p2, a patrol image patrolled by the patrol device is shown as P2 in FIG. 6, a patrol target patrolled by the patrol device in the patrol posture p2 is displayed in the patrol map as shown as T2 in FIG. 6 and a patrol target D2 in T2 is the patrol target patrolled by the patrol device in the patrol posture p2. In the patrol map shown in T2, the patrol target D1 of the patrol device in the patrol posture p1 is displayed in addition to displaying the patrol target D2. A patrol posture p3 is obtained after continuing to adjust the heading angle of the patrol device. In the patrol posture p3, a patrol image patrolled by the patrol device is shown as P3 in FIG. 6, a patrol target patrolled by the patrol device in the patrol posture p3 is displayed in the patrol map as shown as T3 in FIG. 6 and a patrol target D3 in T3 is the patrol target patrolled by the patrol device in the patrol posture p3. In the patrol map shown in T3, the patrol target D1 patrolled by the patrol device in the patrol posture p1 and the patrol target D2 patrolled by the patrol device in the patrol posture p2 are displayed in addition to displaying the patrol target D3; . . . . A patrol posture p1 is obtained after continuing to adjust the heading angle of the patrol device. In the patrol posture p1, the patrol image patrolled by the patrol device is shown as Pi in FIG. 6, a patrol target patrolled by the patrol device in the patrol posture p1 is displayed in the patrol map as shown as Ti in FIG. 6 and a patrol target Di in Ti is the patrol target patrolled by the patrol device in the patrol posture p1. In the patrol map shown in Ti, the patrol targets patrolled by the patrol device in all previous patrol postures are displayed in addition to displaying the patrol target Di.

In the technical solution corresponding to FIG. 2, the patrol targets patrolled by the patrol device at the preset patrol position in multiple patrol postures sequentially and geographical positions of the patrol targets are obtained and then the patrol targets patrolled by the patrol device in multiple different patrol postures are displayed at the geographical positions corresponding to the patrol targets in the patrol map, so that all the patrol targets patrolled by the patrol device at the preset patrol position are displayed in the patrol map, a user may determine all the patrol targets patrolled by the patrol device according to the patrol map, the user does not need to perform whole-process picture monitoring and errors and omissions in target statistics can be avoided. The patrol device patrols the entire patrol area in a manner of patrolling at the preset patrol position in the multiple patrol postures and the patrol device can patrol all the patrol targets in the patrol area by only changing postures at the preset patrol position, so as to avoid multiple flights, thereby shortening a flight time and achieving rapid detection of the patrol targets in the patrol area.

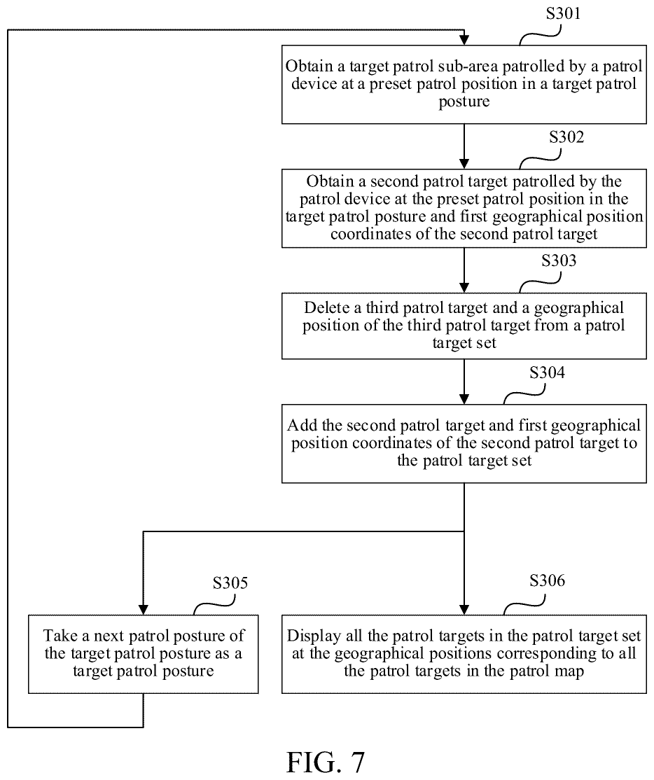

Refer to FIG. 7, which is a schematic flowchart of another patrol target detection method according to an embodiment of the present disclosure. As shown in FIG. 7, the method includes the following operations.

S301: Obtain a target patrol sub-area patrolled by a patrol device at a preset patrol position in a target patrol posture.

Herein, for a specific implementation of operation S301, reference may be made to the foregoing descriptions of operations B1 to B3. Details are not described herein again.

S302: Obtain a second patrol target patrolled by the patrol device at the preset patrol position in the target patrol posture and first geographical position coordinates of the second patrol target.

Herein, for a specific implementation of operation S302, reference may be made to the foregoing descriptions of operations A1 and A2. Details are not described herein again.

S303: Delete a third patrol target and a geographical position of the third patrol target from a patrol target set.

Herein, the patrol target set includes all the patrol targets that the patrol device has patrolled and geographical positions of all the patrol targets. The geographical positions of all the patrol targets in the patrol target set are represented by coordinates in a world coordinate system. In addition to including the patrol targets and the geographical positions of the patrol targets, the patrol target set may further include categories of the patrol targets. The patrol target set may include multiple patrol target sub-sets. Different patrol target sub-sets may include different categories of patrol targets.

The third patrol target is a patrol target located in the target patrol sub-area in the patrol target set. The third patrol target and the geographical position of the third patrol target in the patrol target set are deleted to ensure that the patrol targets and the geographical positions of the patrol targets in the target patrol sub-area in the patrol target set are the latest.

Before deleting the third patrol target and the geographical position of the third patrol target from the patrol target set, whether there is the third patrol target in the patrol target set may be first determined. If there is the third patrol target in the patrol target set, the patrol device has patrolled the target patrol sub-area or partial target patrol sub-area in other previous patrol postures. The patrol target in the target patrol sub-area and the geographical position of the patrol target need to be updated and operation S304 needs to be performed. If there is no third patrol target in the patrol target set, the patrol device has not patrolled the target patrol sub-area other previous patrol postures. Operation S304 may be skipped and operation S305 may be directly performed.

In a feasible implementation, whether there is the third patrol target in the patrol target set may be determined through the following operations C1 to C3.

C1: Determine whether there is a target geographical position located in the target patrol sub-area in the patrol target set.

Specifically, each geographical position in the patrol target set may be compared with the geographical position included in the target patrol sub-area to determine whether each geographical position in the patrol target set is in the target patrol sub-area. If any geographical position in the patrol target set is in the target patrol sub-area, there is the target geographical position located in the target patrol sub-area in the patrol target set. If each geographical position in the patrol target set is not in the target patrol sub-area, there is no target geographical position in the target patrol sub-area in the patrol target set and operation S305 may be directly performed.

C2: Determine, in a case that there is a second geographical position in the patrol target set, that there is a second patrol target in the patrol target set.

C3: Determine, in a case that there is no second geographical position in the patrol target set, that there is no second patrol target in the patrol target set.

The implementation is simple by detecting whether there is the patrol target in the patrol target set by detecting whether there is a target position in the target patrol sub-area in the patrol target set.

S304: Add the second patrol target and first geographical position coordinates of the second patrol target to the patrol target set.

S305: Take a next patrol posture of the target patrol posture as a target patrol posture and return to perform operation S301.

S306: Display all the patrol targets in the patrol target set at the geographical positions corresponding to all the patrol targets in the patrol map.

Herein, for a specific implementation of operation S306, reference may be made to the foregoing related descriptions of operation S202 and content shown in FIG. 6. Details are not described herein again.

In the technical solution corresponding to FIG. 7, after the patrol target patrolled by the patrol device in the target patrol posture and the geographical position of the patrol target are obtained, the patrol target located in the target patrol sub-area and the geographical position of the patrol target located in the target patrol sub-area are deleted from the patrol target set first and then a detected patrol target and the geographical position of the patrol target are added to the patrol target set, so that the patrol target located in the target patrol sub-area and the geographical position of the patrol target located in the target patrol sub-area in the patrol target set are the latest. The user may determine a motion trajectory of the patrol target in a patrol area according to the latest geographical positions of the patrol targets in different patrol sub-areas.

Optionally, in some possible cases, after the patrol targets patrolled by the patrol device at the preset patrol position in the multiple patrol postures sequentially are displayed at the geographical positions corresponding to the patrol targets in the patrol map, in response to a selection instruction acting on a first patrol target in the patrol map, a first patrol image of the first patrol target may be further displayed. The first patrol target is any patrol target displayed in the patrol map. The first patrol image is a patrol image obtained by the patrol device and including the first patrol target, that is, the patrol image of the first patrol target recognized and detected.

The selection instruction may be triggered by the user. For example, when the user clicks on one of the patrol targets displayed on the patrol map, the selection instruction for the patrol target is triggered.

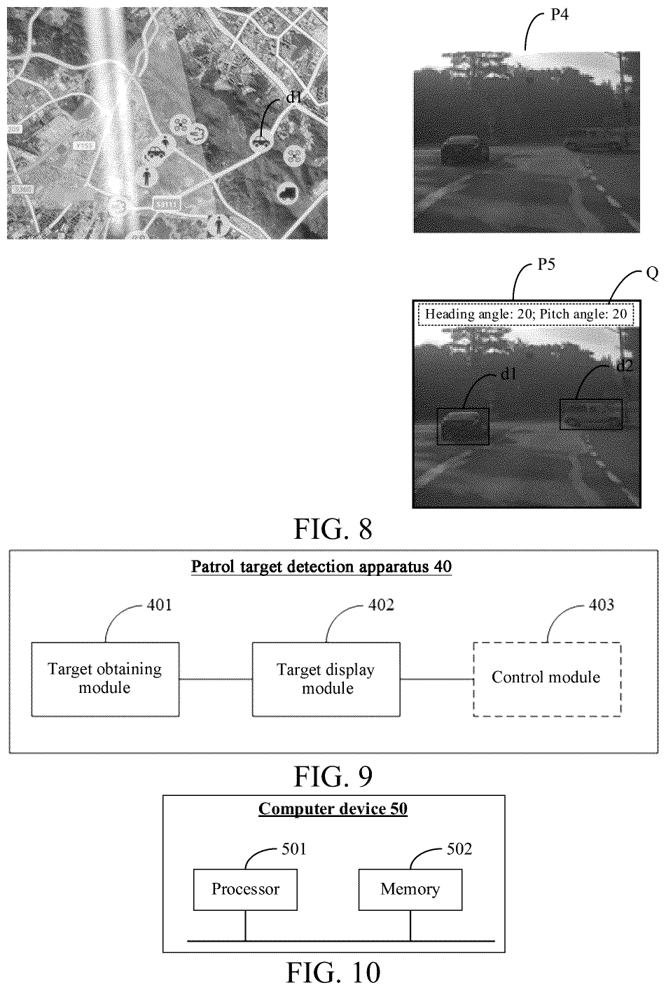

For example, referring to FIG. 8, when the user clicks on a patrol target d1 in the patrol map shown in FIG. 8, P4 in FIG. 8 may be displayed. P4 is a patrol image obtained by the patrol device and including the patrol target d1, that is, the patrol target d1 is recognized from P4.

The patrol image corresponding to the patrol target selected by the user is displayed, so that the user can understand and confirm specific situations of the patrol target.

Optionally, in some possible cases, after the second patrol target patrolled by the patrol device at the preset patrol position in the target patrol posture and the first geographical position coordinates of the second patrol target are added to the patrol target set, a patrol target identifier may be further assigned to the patrolled second patrol target. The patrol target identifier is configured for uniquely identifying the second patrol target in the target patrol sub-area. The patrol target identifiers of the same patrol target in different patrol sub-areas are the same. In this way, each patrol target in the patrol target set may have a corresponding patrol target identifier. After receiving the selection instruction acting on the first patrol target, a first patrol target identifier of the first patrol target may be determined, a geographical position of a patrol target with the patrol target identifier being the first patrol target identifier is searched in the patrol target set and a motion trajectory of the first patrol target is generated based on the searched geographical position of the patrol target with the patrol target identifier being the first patrol target identifier.

Optionally, when the first patrol image is displayed, a first patrol posture corresponding to the first patrol image may be further displayed. The first patrol posture is a patrol posture at which the patrol device obtains the first patrol image.

For example, P4 in FIG. 8 is obtained by the patrol device at a heading angle of 20° and a pitch angle of 60°. A patrol posture {a heading angle: 20; a pitch angle: 20} corresponding to P4 may be further displayed while P4 is displayed A first patrol posture corresponding to the first patrol image may be shown as Q in FIG. 8.

A patrol image corresponding to a patrol target selected by the user and a posture at which the patrol device obtains the patrol image are displayed, so that the user can confirm a relative orientation between the patrol target and the patrol device, which is helpful for the user to issue a patrol instruction to the patrol device.

Optionally, a patrol target in the first patrol image may be further displayed when the first patrol image is displayed.

For example, the first patrol image is shown as P4 in FIG. 6. In the first patrol image, there is a patrol target d2 in addition to the patrol target d1. Both the patrol target d1 and the patrol target d2 are patrol targets in the first patrol image. When a first patrol image P1 is displayed, the patrol target d1 and the patrol target d2 are further marked in the first patrol image. The first patrol target in the first patrol image is displayed as shown as P5 in FIG. 6.

The patrol image corresponding to the patrol target selected by the user and the patrol target in the patrol image are displayed, so that the user can understand and confirm specific situations of the patrol target.

Optionally, an obtaining time of the first patrol image may be further displayed when the first patrol image is displayed. In this way, the user can confirm a time at which the patrol target appears, thereby determining a motion trajectory of the patrol target.

Optionally, after the first patrol image corresponding to the first patrol target is displayed, the patrol device may further be controlled to perform a secondary patrol on a patrol sub-area corresponding to the first patrol image in the first patrol posture in response to a patrol instruction acting on the first patrol image. The patrol instruction includes a patrol posture at which the patrol device obtains the first patrol image.

The patrol instruction is configured for indicating to perform the secondary patrol on the patrol sub-area corresponding to the first patrol image. The patrol instruction may be triggered by the user. The patrol device may be controlled to be adjusted to the first patrol posture and to re-obtain the patrol image in the first patrol posture. The patrol target in the patrol sub-area corresponding to the first patrol image and the position of the patrol target are determined according to the patrol image re-obtained by the patrol device, thereby achieving the secondary patrol.

The patrol device is controlled to perform the secondary patrol on the patrol sub-area corresponding to the patrol image, so that the user can further confirm the specific situations of the patrol target.

The foregoing describes the method of the present disclosure and the following describes an apparatus of the present disclosure.

In this technical solution, the patrol targets patrolled by the patrol device at the preset patrol position in multiple patrol postures sequentially and geographical positions of the patrol targets are obtained and then the patrol targets patrolled by the patrol device in multiple different patrol postures are displayed at the geographical positions corresponding to the patrol targets in the patrol map, so that all the patrol targets patrolled by the patrol device at the preset patrol position are displayed in the patrol map, a user may determine all the patrol targets patrolled by the patrol device according to the patrol map, the user does not need to perform whole-process picture monitoring and errors and omissions in target statistics can be avoided. The patrol device patrols the entire patrol area in a manner of patrolling at the preset patrol position in the multiple patrol postures and the patrol device can patrol all the patrol targets in the patrol area by only changing postures at the preset patrol position, so as to avoid multiple flights, thereby shortening a flight time and achieving rapid detection of the patrol targets in the patrol area.

With reference to the first aspect, in a possible implementation, after the displaying the patrol targets at the geographical positions in the patrol map, the method further includes: displaying, in response to a selection instruction acting on a first patrol target in the patrol map, a first patrol image corresponding to the first patrol target. The first patrol target is any patrol target displayed in the patrol map, and the first patrol image is a patrol image obtained by the patrol device and including the first patrol target. The patrol image corresponding to the patrol target selected by the user is displayed, so that the user can understand and confirm specific situations of the patrol target.

With reference to the first aspect, in a possible implementation, the displaying a first patrol image corresponding to the first patrol target includes: displaying the first patrol image and a first patrol posture corresponding to the first patrol image. The first patrol posture is a patrol posture at which the patrol device obtains the first patrol image. The patrol image corresponding to the patrol target selected by the user and a posture at which the patrol device obtains the patrol image are displayed, so that the user can perform a secondary patrol.

With reference to the first aspect, in a possible implementation, the displaying a first patrol image corresponding to the first patrol target further includes: displaying the first patrol image and a patrol target in the first patrol image. The patrol image corresponding to the patrol target selected by the user and the patrol target in the patrol image are displayed, so that the user can understand and confirm specific situations of the patrol target.

With reference to the first aspect, in a possible implementation, after the displaying a first patrol image corresponding to the first patrol target, the method further includes: obtaining a patrol instruction of the patrol device that shoots the first patrol image, and controlling the patrol device to perform a secondary patrol on a patrol sub-area corresponding to the first patrol image in the first patrol posture corresponding to the first patrol image. The first patrol posture is the patrol posture at which the patrol device obtains the first patrol image. The patrol device is controlled to perform the secondary patrol on the patrol sub-area corresponding to the patrol image, so that the user can further confirm the specific situations of the patrol target.

With reference to the first aspect, in a possible implementation, the preset patrol position corresponds to a center position of the patrol area.

With reference to the first aspect, in a possible implementation, the obtaining patrol targets patrolled by a patrol device at a preset patrol position in multiple patrol postures sequentially and geographical positions of the patrol targets includes: obtaining a patrol target patrolled by the patrol device at the preset patrol position in a second patrol posture and a geographical position of the patrol target, where the second patrol posture includes a first angle and a second angle, the first angle is a heading angle and the second angle is a pitch angle, or the first angle is a pitch angle and the second angle is a heading angle; determining whether the first angle in the second patrol posture is equal to a final first angle; updating, in a case that the first angle in the second patrol posture is not equal to the final first angle, the first angle in the second patrol posture to a sum of the first angle in the second patrol posture and a first angle adjustment step size, and returning to perform the operation of obtaining the patrol target patrolled by the patrol device at the preset patrol position in the second patrol posture and the geographical position of the patrol target; or updating, in a case that the first angle in the second patrol posture is equal to the final first angle, the first angle in the second patrol posture to an initial first angle, updating the second angle in the second patrol posture to a sum of the second angle in the second patrol posture and a second angle adjustment step size, and returning to perform the operation of obtaining a patrol target patrolled by the patrol device at the preset patrol position in a target posture and a geographical position of the patrol target.

With reference to the first aspect, in a possible implementation, the obtaining patrol targets patrolled by a patrol device at a preset patrol position in multiple patrol postures sequentially and geographical positions of the patrol targets includes: performing patrol target recognition on a second patrol image to obtain a second patrol target and first image coordinates of the second patrol target in the second patrol image, where the second patrol image is a patrol image obtained by the patrol device at the preset patrol position in a target patrol posture, and the target patrol posture is any patrol posture of the multiple patrol postures; and performing coordinate conversion on the first image coordinates to obtain first geographical position coordinates of the second patrol target, where the first geographical position coordinates are coordinates in a world coordinate system. The geographical positions of the patrol targets are determined through target recognition and coordinate conversion, so that the geographical positions of the patrol targets can be accurately determined.

With reference to the first aspect, in a possible implementation, the obtaining patrol targets patrolled by a patrol device at a preset patrol position in multiple patrol postures sequentially and geographical positions of the patrol targets further includes: obtaining a target sub-patrol area patrolled by the patrol device at the preset patrol position in the target patrol posture; deleting a third patrol target and a geographical position of the third patrol target from a patrol target set, where the patrol target set includes all patrol targets that the patrol device has patrolled and geographical positions of all the patrol targets, and the third patrol target is a patrol target located in the target sub-patrol area in the patrol target set; adding the second patrol target and the first geographical position coordinates to the patrol target set; and the displaying the patrol targets at the geographical positions in the patrol map includes: displaying all the patrol targets in the patrol target set at the geographical positions corresponding to all the patrol targets in the patrol map. The patrol targets located in the target sub-patrol area in the patrol target set and the geographical positions of the patrol targets located in a target patrol sub-area are deleted first, and then the detected patrol targets and the geographical positions of the patrol targets are added to the patrol target set, so that the geographical positions in the patrol target set can be final positions where the patrol targets appear in the patrol sub-area, and the user can track motion trajectories of the patrol targets.

With reference to the first aspect, in a possible implementation, after the adding the second patrol target and the first geographical position coordinates to the patrol target set, the method further includes: taking a next patrol posture of the target patrol posture as the target patrol posture, and performing the operation of obtaining a target sub-patrol area patrolled by the patrol device at the preset patrol position in the target patrol posture.

With reference to the first aspect, in a possible implementation, the obtaining a target sub-patrol area patrolled by the patrol device at the preset patrol position in the target patrol posture includes: determining a patrol map area corresponding to the second patrol image as the target patrol sub-area.

With reference to the first aspect, in a possible implementation, before the determining a patrol map area corresponding to the second patrol image as the target patrol sub-area, the method further includes: obtaining vertex image coordinates of the second patrol image, where the vertex image coordinates are coordinates in a pixel coordinate system; and performing coordinate conversion on the vertex image coordinates to obtain patrol position coordinates corresponding to the second patrol image, where the patrol position coordinates are coordinates in a world coordinate system; and determining, in the patrol map, a sub-area enclosed by the patrol position coordinates as the patrol map area corresponding to the second patrol image. The patrol sub-area of the patrol device is determined by obtaining an image and performing coordinate conversion, so that the patrol sub-area of the patrol device can be accurately determined.

With reference to the first aspect, in a possible implementation, the performing patrol target recognition on a second patrol image to obtain a second patrol target and first image coordinates of the second patrol target in the second patrol image includes: performing patrol target recognition on the second patrol image through a target recognition model to obtain the second patrol target and the first image coordinates of the second patrol target in the second patrol image.

With reference to the first aspect, in a possible implementation, the performing coordinate conversion on the first image coordinates to obtain first geographical position coordinates of the second patrol target includes: determining a target conversion matrix according to the target patrol posture and the first device coordinates corresponding to the preset patrol position, where the target conversion matrix is configured to represent a conversion relationship between the pixel coordinate system and the world coordinate system when the patrol device obtains the second patrol image at the preset patrol position in the target patrol posture; and performing coordinate conversion on the first image coordinates according to the target conversion matrix to obtain the first geographical position coordinates.

Refer to FIG. 9, which is a schematic structural diagram of a patrol target detection apparatus according to an embodiment of the present disclosure. As shown in FIG. 9, the patrol target detection apparatus 40 includes:

a target obtaining module 401, configured to obtain patrol targets patrolled by a patrol device at a preset patrol position in multiple patrol postures sequentially and geographical positions of the patrol targets, where the multiple patrol postures are different and patrol sub-areas patrolled by the patrol device at the preset patrol position in the multiple patrol postures sequentially form a patrol area; and

a target display module 402, configured to display the patrol targets at the geographical positions in a patrol map.

In a possible design, the foregoing target display module 402 is further configured to: obtain a patrol instruction of the patrol device that shoots the first patrol image and display a first patrol image corresponding to the first patrol target. The first patrol target is any patrol target displayed in the patrol map. The first patrol image is a patrol image obtained by the patrol device and including the first patrol target.

In a possible design, the foregoing target display module 402 is specifically configured to: display the first patrol image and a first patrol posture corresponding to the first patrol image. The first patrol posture is a patrol posture at which the patrol device obtains the first patrol image.

In a possible design, the foregoing target display module 402 is specifically configured to: display the first patrol image and a patrol target in the first patrol image.

In a possible design, the foregoing patrol target detection apparatus 40 further includes a control module 403, configured to control the patrol device to perform, in response to a patrol instruction acting on the first patrol image, a secondary patrol on a patrol sub-area corresponding to the first patrol image in the first patrol posture corresponding to the first patrol image. The first patrol posture is a patrol posture at which the patrol device obtains the first patrol image.

In a possible design, the preset patrol position corresponds to a center position of the patrol area.

In a possible design, the foregoing target obtaining module 401 is specifically configured to: obtain a patrol target patrolled by the patrol device at a preset patrol position in a second patrol posture and a geographical position of the patrol target, where the second patrol posture includes a first angle and a second angle, the first angle is a heading angle and the second angle is a pitch angle, or the first angle is the pitch angle and the second angle is the heading angle; determine whether the first angle in the second patrol posture is equal to a final first angle; update, in a case that the first angle in the second patrol posture is not equal to the final first angle, the first angle in the second patrol posture to a sum of the first angle in the second patrol posture and a first angle adjustment step size and return to perform the operation of obtaining the patrol target patrolled by the patrol device at the preset patrol position in the second patrol posture and the geographical position of the patrol target; or update, in a case that the first angle in the second patrol posture is equal to the final first angle, the first angle in the second patrol posture to an initial first angle, update the second angle in the second patrol posture to a sum of the second angle in the second patrol posture and a second angle adjustment step size and return to perform the operation of obtaining a patrol target patrolled by the patrol device at the preset patrol position in a target posture and a geographical position of the patrol target.

In a possible design, the foregoing target obtaining module 401 is specifically configured to: perform patrol target recognition on the second patrol image to obtain a second patrol target and first image coordinates of the second patrol target in the second patrol image, where the second patrol image is a patrol image obtained by the patrol device at the preset patrol position in a target patrol posture and the target patrol posture is any of the multiple patrol postures; and perform coordinate conversion on the first image coordinates to obtain first geographical position coordinates of the second patrol target, where the first geographical position coordinates are coordinates in a world coordinate system.

In a possible design, the foregoing target obtaining module 401 is specifically configured to: obtain a target sub-patrol area patrolled by the patrol device at the preset patrol position in the target patrol posture; and delete a third patrol target and a geographical position of the third patrol target from a patrol target set, where the patrol target set includes all patrol targets that the patrol device has patrolled and geographical positions of all the patrol target and the third patrol target is a patrol target located in the target sub-patrol area in the patrol target set; and add the second patrol target and the first geographical position coordinates to the patrol target set.

In a possible design, the foregoing target obtaining module 401 is specifically configured to: take a next patrol posture of the target patrol posture as a target patrol posture and perform the operation of obtaining a target sub-patrol area patrolled by the patrol device at the preset patrol position in the target patrol posture.

In a possible design, the foregoing target obtaining module 401 is specifically configured to: determine a patrol map area corresponding to the second patrol image as the target patrol sub-area.

In a possible design, the foregoing target obtaining module 401 is specifically configured to: obtain vertex image coordinates of the second patrol image, where the vertex image coordinates are coordinates in a pixel coordinate system; and perform coordinate conversion on the vertex image coordinates to obtain patrol position coordinates corresponding to the second patrol image, where the patrol position coordinates being coordinates in a world coordinate system; and determine, in the patrol map, a sub-area enclosed by the patrol position coordinates as the patrol map area corresponding to the second patrol image.

In a possible design, the foregoing target obtaining module 401 is specifically configured to: perform patrol target recognition on the second patrol image by using a target recognition model to obtain a second patrol target and first image coordinates of the second patrol target in the second patrol image.

In a possible design, the foregoing target obtaining module 401 is specifically configured to: determine a target conversion matrix according to the target patrol posture and first device position coordinates corresponding to the preset patrol position, where the target conversion matrix is configured for representing a conversion relationship between a pixel coordinate system and a world coordinate system when the patrol device obtains the second patrol image at the preset patrol position in the target patrol posture; and perform coordinate conversion on the first image coordinates according to the target conversion matrix to obtain the first geographical position coordinates.

It is to be noted that, for content not mentioned in the embodiment corresponding to FIG. 9, reference may be made to the descriptions of the foregoing method embodiments. Details are not described herein again.

According to the foregoing apparatus, the patrol targets patrolled by the patrol device at the preset patrol position in multiple patrol postures sequentially and geographical positions of the patrol targets are obtained and then the patrol targets patrolled by the patrol device in multiple different patrol postures are displayed at the geographical positions corresponding to the patrol targets in the patrol map, so that all the patrol targets patrolled by the patrol device at the preset patrol position are displayed in the patrol map, a user may determine all the patrol targets patrolled by the patrol device according to the patrol map, the user does not need to perform whole-process picture monitoring and errors and omissions in target statistics can be avoided. The patrol device patrols the entire patrol area in a manner of patrolling at the preset patrol position in the multiple patrol postures and the patrol device can patrol all the patrol targets in the patrol area by only changing postures at the preset patrol position, so as to avoid multiple flights, thereby shortening a flight time and achieving rapid detection of the patrol targets in the patrol area.

Refer to FIG. 10, which is a schematic structural diagram of a computer device according to an embodiment of the present disclosure. The computer device 50 includes a processor 501 and a memory 502. The memory 502 is connected to the processor 501, for example, is connected to the processor 501 through a bus.

The processor 501 is configured to support the computer device 50 to perform corresponding functions in the method in the foregoing method embodiments. The processor 501 may be a central processing unit (CPU), a network processor (NP), a hardware chip, or any combination thereof. The foregoing hardware chip may be an application specific integrated circuit (ASIC), a programmable logic device (PLD), or a combination thereof. The foregoing PLD may be a complex programmable logic device (CPLD), a field-programmable gate array (FPGA), a general array logic (GAL), or any combination thereof.

The memory 502 is configured to store program code and the like. The memory 502 may include a volatile memory (VM), for example, a random access memory (RAM). The memory 502 may alternatively include a non-volatile memory (NVM), for example, a read-only memory (ROM), a flash memory, a hard disk drive (HDD), or a solid-state drive (SSD).

The memory 502 may alternatively include a combination of the foregoing types of memories.

The processor 501 may invoke the program code to perform the following operations:
obtaining patrol targets patrolled by a patrol device at a preset patrol position in multiple patrol postures sequentially and geographical positions of the patrol targets, where the multiple patrol postures are different and patrol sub-areas patrolled by the patrol device at the preset patrol position in the multiple patrol postures sequentially form a patrol area; and
displaying the patrol targets at the geographical positions in a patrol map.

An embodiment of the present disclosure further provides a computer-readable storage medium. The computer-readable storage medium stores a computer program. The computer program includes program instructions. The program instructions, when executed by a computer, enables the computer to perform the method according to the foregoing embodiments.

A person of ordinary skill in the art may understand that all or part processes of the methods in the foregoing embodiments may be implemented by a computer program instructing relevant hardware. The program may be stored in a computer-readable storage medium. When the program is executed, the processes of the foregoing method embodiments may be implemented. The storage medium may be a magnetic disk, an optical disk, a ROM, a RAM, or the like.

What is disclosed above is merely preferred embodiments of the present disclosure and certainly is not intended to limit the scope of claims of the present disclosure. Therefore, equivalent variations made in accordance with the claims of the present disclosure still fall within the scope of the present disclosure.

What is claimed is:

1. A patrol target detection method, comprising:
obtaining patrol targets patrolled by a patrol device at a preset patrol position in a plurality of patrol postures sequentially and geographical positions of the patrol targets, the plurality of patrol postures being different, patrol sub-areas patrolled by the patrol device at the preset patrol position in the plurality of patrol postures sequentially forming a patrol area; and
displaying the patrol targets at the geographical positions in a patrol map.

2. The patrol target detection according to claim 1, after the displaying the patrol targets at the geographical positions in a patrol map, further comprising:
displaying, in response to a selection instruction acting on a first patrol target in the patrol map, a first patrol image corresponding to the first patrol target, the first patrol target being any patrol target displayed in the patrol map, the first patrol image being a patrol image obtained by the patrol device and comprising the first patrol target.

3. The patrol target detection method according to claim 2, wherein the displaying a first patrol image corresponding to the first patrol target comprises:
displaying the first patrol image and a first patrol posture corresponding to the first patrol image, the first patrol posture being a patrol posture at which the patrol device obtains the first patrol image.

4. The patrol target detection according to claim 2, wherein the displaying a first patrol image corresponding to the first patrol target further comprises:
displaying the first patrol image and a patrol target in the first patrol image.

5. The patrol target detection method according to claim 2, after the displaying a first patrol image corresponding to the first patrol target, further comprising:
obtaining a patrol instruction of the patrol device that shoots the first patrol image and controlling the patrol device to perform a secondary patrol on a patrol sub-area corresponding to the first patrol image in a first patrol posture corresponding to the first patrol image, the first patrol posture being a patrol posture at which the patrol device obtains the first patrol image.

6. The patrol target detection method according to claim 1, wherein the preset patrol position corresponds to a central position of the patrol area.

7. The patrol target detection method according to claim 1, wherein the obtaining patrol targets patrolled by a patrol device at a preset patrol position in a plurality of patrol postures sequentially and geographical positions of the patrol targets comprises:
obtaining a patrol target patrolled by the patrol device at the preset patrol position in a second patrol posture and a geographical position of the patrol target, the second patrol posture comprising a first angle and a second angle, the first angle being a heading angle, the second angle being a pitch angle, or the first angle being the pitch angle, the second angle being the heading angle;
determining whether the first angle in the second patrol posture is equal to a final first angle; and
updating, in a case that the first angle in the second patrol posture is not equal to the final first angle, the first angle in the second patrol posture to a sum of the first angle in the second patrol posture and a first angle adjustment step size and returning to perform the operation of obtaining a patrol target patrolled by the patrol device at the preset patrol position in a second patrol posture and a geographical position of the patrol target; or
updating, in a case that the first angle in the second patrol posture is equal to the final first angle, the first angle in the second patrol posture to an initial first angle, updating the second angle in the second patrol posture to a sum of the second angle in the second patrol posture and a second angle adjustment step size and returning to perform the operation of obtaining a patrol target patrolled by the patrol device at the preset patrol position in a target posture and a geographical position of the patrol target.

8. The patrol target detection method according to claim 1, wherein the obtaining patrol targets patrolled by a patrol device at a preset patrol position in a plurality of patrol postures sequentially and geographical positions of the patrol targets comprises:
performing patrol target recognition on a second patrol image to obtain a second patrol target and first image coordinates of the second patrol target in the second patrol image, the second patrol image being a patrol image obtained by the patrol device at the preset patrol position in a target patrol posture, the target patrol posture being any of the plurality of patrol postures; and
performing coordinate conversion on the first image coordinates to obtain first geographical position coordinates of the second patrol target, the first geographical position coordinates being coordinates in a world coordinate system.

9. The patrol target detection method according to claim 8, wherein the obtaining patrol targets patrolled by a patrol device at a preset patrol position in a plurality of patrol postures sequentially and geographical positions of the patrol targets further comprises:
obtaining a target sub-patrol area patrolled by the patrol device at the preset patrol position in the target patrol posture;
deleting a third patrol target and a geographical position of the third patrol target from a patrol target set, the patrol target set comprising all patrol targets that the patrol device has patrolled and geographical positions of all the patrol targets, the third patrol target being a patrol target located in the target sub-patrol area in the patrol target set; and
adding the second patrol target and the first geographical position coordinates to the patrol target set; and
the displaying the patrol target at the geographical position in the patrol map comprises:
displaying all the patrol targets in the patrol target set at the geographical positions corresponding to all the patrol targets in the patrol map.

10. The patrol target detection method according to claim 8, after the adding the second patrol target and the first geographical position coordinates to the patrol target set, further comprising:
taking a next patrol posture of the target patrol posture as the target patrol posture and performing the operation of obtaining a target sub-patrol area patrolled by the patrol device at the preset patrol position in the target patrol posture.

11. A patrol target detection apparatus, comprising:
a target obtaining module, configured to obtain patrol targets patrolled by a patrol device at a preset patrol position in a plurality of patrol postures sequentially and geographical positions of the patrol targets, the plurality of patrol postures being different, patrol sub-areas patrolled by the patrol device at the preset patrol position in the plurality of patrol postures sequentially forming a patrol area; and
a target display module, configured to display the patrol targets at the geographical positions in a patrol map.

12. The patrol target detection apparatus according to claim 11, wherein the target display module is configured to display, in response to a selection instruction acting on a first patrol target in the patrol map, a first patrol image corresponding to the first patrol target, the first patrol target being any patrol target displayed in the patrol map, the first patrol image being a patrol image obtained by the patrol device and comprising the first patrol target.

13. The patrol target detection apparatus according to claim 12, wherein the target display module is configured to display a first patrol image corresponding to the first patrol target comprises:
display the first patrol image and a first patrol posture corresponding to the first patrol image, the first patrol posture being a patrol posture at which the patrol device obtains the first patrol image.

14. The patrol target detection apparatus according to claim 12, wherein the target display module is further configured to:
display the first patrol image and a patrol target in the first patrol image.

15. The patrol target detection apparatus according to claim 12, wherein the target obtaining module is further configured to:
obtain a patrol instruction of the patrol device that shoots the first patrol image and controlling the patrol device to perform a secondary patrol on a patrol sub-area corresponding to the first patrol image in a first patrol posture corresponding to the first patrol image, the first patrol posture being a patrol posture at which the patrol device obtains the first patrol image.

16. The patrol target detection apparatus according to claim 11, wherein the preset patrol position corresponds to a central position of the patrol area.

17. The patrol target detection apparatus according to claim 11, wherein the target obtaining module is configured to:
obtain a patrol target patrolled by the patrol device at the preset patrol position in a second patrol posture and a geographical position of the patrol target, the second patrol posture comprising a first angle and a second angle, the first angle being a heading angle, the second angle being a pitch angle, or the first angle being the pitch angle, the second angle being the heading angle;
determine whether the first angle in the second patrol posture is equal to a final first angle; and
update, in a case that the first angle in the second patrol posture is not equal to the final first angle, the first angle in the second patrol posture to a sum of the first angle in the second patrol posture and a first angle adjustment step size and returning to perform the operation of obtaining a patrol target patrolled by the patrol device at the preset patrol position in a second patrol posture and a geographical position of the patrol target; or
update, in a case that the first angle in the second patrol posture is equal to the final first angle, the first angle in the second patrol posture to an initial first angle, update the second angle in the second patrol posture to a sum of the second angle in the second patrol posture and a second angle adjustment step size and returning to perform the operation of obtaining a patrol target patrolled by the patrol device at the preset patrol position in a target posture and a geographical position of the patrol target.

18. The patrol target detection apparatus according to claim 17, wherein the target obtaining module is configured to:
perform patrol target recognition on a second patrol image to obtain a second patrol target and first image coordinates of the second patrol target in the second patrol image, the second patrol image being a patrol image obtained by the patrol device at the preset patrol position in a target patrol posture, the target patrol posture being any of the plurality of patrol postures; and
perform coordinate conversion on the first image coordinates to obtain first geographical position coordinates of the second patrol target, the first geographical position coordinates being coordinates in a world coordinate system.

19. The patrol target detection apparatus according to claim 18, wherein the target obtaining module is configured to:
obtain a target sub-patrol area patrolled by the patrol device at the preset patrol position in the target patrol posture;
delete a third patrol target and a geographical position of the third patrol target from a patrol target set, the patrol target set comprising all patrol targets that the patrol device has patrolled and geographical positions of all the patrol targets, the third patrol target being a patrol target located in the target sub-patrol area in the patrol target set; and
add the second patrol target and the first geographical position coordinates to the patrol target set; and
the display the patrol target at the geographical position in the patrol map comprises:
display all the patrol targets in the patrol target set at the geographical positions corresponding to all the patrol targets in the patrol map.

20. A non-transitory computer-readable storage medium, having a computer program stored therein, the computer program comprising program instructions, the program instructions, when executed by a processor, enabling the processor to perform a patrol target detection method, wherein the patrol target detection method comprising:
obtaining patrol targets patrolled by a patrol device at a preset patrol position in a plurality of patrol postures sequentially and geographical positions of the patrol targets, the plurality of patrol postures being different, patrol sub-areas patrolled by the patrol device at the preset patrol position in the plurality of patrol postures sequentially forming a patrol area; and
displaying the patrol targets at the geographical positions in a patrol map.
